(19) United States
(12) Patent Application Publication
(10) Pub. No.: US 2014/0267222 A1
(43) Pub. Date: Sep. 18, 2014

(54) EFFICIENT AUTOSTEREO SUPPORT USING DISPLAY CONTROLLER WINDOWS

(71) Applicant: NVIDIA CORPORATION, Santa Clara, CA (US)

(72) Inventors: Karan GUPTA, Noida (IN); Mark Ernest VAN NOSTRAND, Dripping Springs, TX (US); Preston Chui, Santa Clara, CA (US)

(73) Assignee: NVIDIA CORPORATION, Santa Clara, CA (US)

(21) Appl. No.: 13/797,516

(22) Filed: Mar. 12, 2013

(51) Int. Cl. G06T 19/20

(52) U.S. Cl. CPC G06T 19/20
USPC 345/419

(57) ABSTRACT

An approach is provided for efficient autostereoscopic support by using a display controller for controlling a display screen of a display system. In one example, the display controller includes the following hardware components: an image receiver configured to receive image data from a source, wherein the image data includes a first image and a second image; a first window controller configured to receive the first image from the image receiver and to scale the first image according to parameters of the display screen in order to generate a scaled first image; a second window controller configured to receive the second image from the image receiver and to scale the second image according to the parameters of the display screen in order to generate a scaled second image; and a blender component configured to interleave the scaled first image with the scaled second image in order to generate a stereoscopic composited image.

### BACKGROUND OF THE INVENTION

1. Field of the Invention

The present invention relates generally to display systems and, more specifically, to efficient autostereo (autostereoscopic) support using display controller windows.

2. Description of the Related Art

Autostereoscopy is a method of displaying stereoscopic images (e.g., adding binocular perception of three-dimensional (3D) depth) without the use of special headgear or glasses on the part of the viewer. In contrast, monoscopic images are perceived by a viewer as being two-dimensional (2D). Because headgear is not required, autostereoscopy is also called “glasses-free 3D” or “glassesless 3D”. There are two broad approaches currently used to accommodate motion parallax and wider viewing angles: (1) eye-tracking and (2) multiple views so that the display does not need to sense where the viewers' eyes are located.

Examples of autostereoscopic displays technology include lenticular lens, parallax barrier, volumetric display, holographic and light field displays. Most flat-panel solutions employ parallax barriers or lenticular lenses that redirect imagery to several viewing regions. When the viewer's head is in a certain position, a different image is seen with each eye, giving a convincing illusion of 3D. Such displays can have multiple viewing zones, thereby allowing multiple users to view the image at the same time.

Autostereoscopy can achieve a 3D effect by performing interleaving operations on images that are to be displayed. Autostereoscopic images (a.k.a., “glassesless stereoscopic images” or “glassesless 3D images”) may be interleaved by using various formats. Example formats for interleaving autostereoscopic images include row interleave, column interleave, checkerboard interleave, and sub-pixel interleave. For such interleaving format, software instructs a rendering engine to render images separately for a left frame (e.g., frame for left eye) and a right frame (e.g., frame for right eye). The software then instructs the rendering engine to send the separate frames to different memory surfaces in a memory.

In a conventional system, software uses an alternative engine (e.g., 3D engine, 2D engine, etc.) to fetch the left frame and the right frame surface from the memory, to pack the fetched frames into a corresponding autostereoscopic image format, and then to write the fetched frames back to the memory. For example, in row interleaved autostereo, software has alternate left/right rows in the final autostereoscopic image written to the memory. Eventually, the display fetches the generated autostereoscopic image from memory and then scans out the autostereoscopic image on the display screen (e.g., display panel) for viewing.

Unfortunately, since software instructs the generation of the autostereoscopic image to be handled by a different unit than the original rendering engine, the scanning of the autostereoscopic image requires an additional memory pass (e.g., both an additional read from memory and an additional write to memory). The additional memory pass slows down the system according to a memory bandwidth or a memory input/output (I/O) power overhead. For example, a 1920 pixels×1200 pixels display at 60 frames/second at 4 bits per pixel×2 instructions (read and write)=1.105 gigabits pixels/second or about 99 mill watts of memory I/O power overhead (assuming 110 mW/GBps). Thus, the additional read and write instructions that are required by such a display system, which is managed by software, add a significant amount of operational latency.

Accordingly, what is needed is an approach for carrying out autostereoscopic operations for a display in a more efficient manner.

### SUMMARY OF THE INVENTION

One implementation of the present approach includes a display controller for controlling a display screen of a display system. In one example, the display controller includes the following hardware components: an image receiver configured to receive image data from a source, wherein the image data includes a first image and a second image; a first window controller coupled to the image receiver and configured to receive the first image from the image receiver and to scale the first image according to parameters of the display screen in order to generate a scaled first image; a second window controller coupled to the image receiver and configured to receive the second image from the image receiver and to scale the second image according to the parameters of the display screen in order to generate a scaled second image; and a blender component coupled to the first and second window controllers and configured to interleave the scaled first image with the scaled second image in order to generate a stereoscopic composited image, wherein the blender component is further configured to scan out the stereoscopic composited image to the display screen without accessing a memory that stores additional data associate with the stereoscopic composited image.

The present approach provides advantages because the display system is configured with hardware components that save the display system from having to perform an additional memory pass before scanning the composited image to the display screen. Accordingly, the display system reduces the corresponding memory bandwidth issues and/or the memory input/output (I/O) power overhead issues that are suffered by conventional systems. Also, because the display system performs fewer passes to memory, the display system consumes less power. Accordingly, where the display system is powered by a battery, the display system draws less battery power and thereby enables the battery charge period to be extended. By using hardware components, the display controller natively supports interleaving images of two hardware window controllers to generate a stereoscopic composited image. The display controller also supports blending the stereoscopic composited image with a monoscopic image and/or with a pre-composited image.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a display system configured to implement one or more aspects of the present invention

FIG. 2 is a block diagram illustrating a parallel processing subsystem, according to one embodiment of the present invention.

FIG. 3 is a block diagram of an example display system, according to one embodiment of the present invention.

FIG. 4 is a conceptual diagram illustrating stereoscopic pixel interleaving from a pre-decimated source, according to one embodiment of the present invention.

FIG. 5 is a conceptual diagram illustrating stereoscopic pixel interleaving from a non-pre-decimated source, according to one embodiment of the present invention.

FIG. 6 is a conceptual diagram illustrating stereoscopic sub-pixel interleaving, according to one embodiment of the present invention.

FIG. 7A is a conceptual diagram illustrating a monoscopic window that is scanned out over a stereoscopic window, according to one embodiment of the present invention.

FIG. 7B is a conceptual diagram illustrating a stereoscopic window that is scanned out over a monoscopic window, according to one embodiment of the present invention.

### DETAILED DESCRIPTION OF EXEMPLARY EMBODIMENTS

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

Among other things, embodiments of the present invention are directed towards a display controller for controlling a display screen of a display system. The display controller includes an image receiver configured to receive image data from a source, wherein the image data includes a first image and a second image. The display controller includes a first window controller coupled to the image receiver and configured to receive the first image from the image receiver and to scale the first image according to parameters of the display screen in order to generate a scaled first image. The display controller includes a second window controller coupled to the image receiver and configured to receive the second image from the image receiver and to scale the second image according to the parameters of the display screen in order to generate a scaled second image. The display controller includes a blender component coupled to the first and second window controllers and configured to interleave the scaled first image with the scaled second image in order to generate a stereoscopic composited image. The blender component is further configured to scan out the stereoscopic composited image to the display screen before obtaining additional data associate with the image data.

### Hardware Overview

FIG. 1 is a block diagram illustrating a display system 100 configured to implement one or more aspects of the present invention. FIG. 1 in no way limits or is intended to limit the scope of the present invention. System 100 may be an electronic visual display, tablet computer, laptop computer, smart phone, mobile phone, mobile device, personal digital assistant, personal computer or any other device suitable for practicing one or more embodiments of the present invention. A device is hardware or a combination of hardware and software. A component is typically a part of a device and is hardware or a combination of hardware and software.

The display system 100 includes a central processing unit (CPU) 102 and a system memory 104 that includes a device driver 103. CPU 102 and system memory 104 communicate via an interconnection path that may include a memory bridge 105. Memory bridge 105, which may be, for example, a Northbridge chip, is connected via a bus or other communication path 106 (e.g., a HyperTransport link, etc.) to an input/output (I/O) bridge 107. I/O bridge 107, which may be, for example, a Southbridge chip, receives user input from one or more user input devices 108 (e.g., touch screen, cursor pad, keyboard, mouse, etc.) and forwards the input to CPU 102 via path 106 and memory bridge 105. A parallel processing subsystem 112 is coupled to memory bridge 105 via a bus or other communication path 113 (e.g., peripheral component interconnect (PCI) express, Accelerated Graphics Port (AGP), and/or HyperTransport link, etc.). In one implementation, parallel processing subsystem 112 is a graphics subsystem that delivers pixels to a display screen 111 (e.g., a conventional cathode ray tube (CRT) and/or liquid crystal display (LCD) based monitor, etc.). A system disk 114 is also connected to I/O bridge 107. A switch 116 provides connections between I/O bridge 107 and other components such as a network adapter 118 and various add-in cards 120 and 121. Other components (not explicitly shown), including universal serial bus (USB) and/or other port connections, compact disc (CD) drives, digital video disc (DVD) drives, film recording devices, and the like, may also be connected to I/O bridge 107. Communication paths interconnecting the various components in FIG. 1 may be implemented using any suitable protocols, such as PCI, PCI Express (PCIe), AGP, HyperTransport, and/or any other bus or point-to-point communication protocol(s), and connections between different devices that may use different protocols as is known in the art.

As further described below with reference to FIG. 2, parallel processing subsystem 112 includes parallel processing units (PPUs) configured to execute a software application (e.g., device driver 103) by using circuitry that enables control of a display screen. Those packet types are specified by the communication protocol used by communication path 113. In situations where a new packet type is introduced into the communication protocol (e.g., due to an enhancement to the communication protocol), parallel processing subsystem 112 can be configured to generate packets based on the new packet type and to exchange data with CPU 102 (or other processing units) across communication path 113 using the new packet type.

In one implementation, the parallel processing subsystem 112 incorporates circuitry optimized for graphics and video processing, including, for example, video output circuitry, and constitutes a graphics processing unit (GPU). In another implementation, the parallel processing subsystem 112 incorporates circuitry optimized for general purpose processing, while preserving the underlying computational architecture, described in greater detail herein. In yet another implementation, the parallel processing subsystem 112 may be integrated with one or more other system elements, such as the memory bridge 105, CPU 102, and I/O bridge 107 to form a system-on-chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For instance, in some implementations, system memory 104 is connected to CPU 102 directly rather than through a bridge, and other devices communicate with system memory 104 via memory bridge 105 and CPU 102. In other alternative topologies, parallel processing subsystem 112 is connected to I/O bridge 107 or directly to CPU 102, rather than to memory bridge 105. In still other implementations, I/O bridge 107 and memory bridge 105 might be integrated into a single chip. Large implementations may include two or more CPUs 102 and two or more parallel processing systems 112. The particular components shown herein are optional; for instance, any number of add-in cards or peripheral devices might be supported. In some implementations, switch 116 is eliminated, and network adapter 118 and add-in cards 120, 121 connect directly to I/O bridge 107.

FIG. 2 is a block diagram illustrating a parallel processing subsystem 112, according to one embodiment of the present invention. As shown, parallel processing subsystem 112 includes one or more parallel processing units (PPUs) 202, each of which is coupled to a local parallel processing (PP) memory 204. In general, a parallel processing subsystem includes a number U of PPUs, where U≧1. (Herein, multiple instances of like objects are denoted with reference numbers identifying the object and parenthetical numbers identifying the instance where needed.) PPUs 202 and parallel processing memories 204 may be implemented using one or more integrated circuit devices, such as programmable processors, application specific integrated circuits (ASICs), or memory devices, or in any other technically feasible fashion.

Referring again to FIG. 1, in some implementations, some or all of PPUs 202 in parallel processing subsystem 112 are graphics processors with rendering pipelines that can be configured to perform various tasks related to generating pixel data from graphics data supplied by CPU 102 and/or system memory 104 via memory bridge 105 and bus 113, interacting with local parallel processing memory 204 (which can be used as graphics memory including, e.g., a conventional frame buffer) to store and update pixel data, delivering pixel data to display screen 111, and the like. In some implementations, parallel processing subsystem 112 may include one or more PPUs 202 that operate as graphics processors and one or more other PPUs 202 that are used for general-purpose computations. The PPUs may be identical or different, and each PPU may have its own dedicated parallel processing memory device(s) or no dedicated parallel processing memory device(s). One or more PPUs 202 may output data to screen 111 or each PPU 202 may output data to one or more screens 111.

In operation, CPU 102 is the master processor of the display system 100, controlling and coordinating operations of other system components. In particular, CPU 102 issues commands that control the operation of PPUs 202. In some implementations, CPU 102 writes a stream of commands for each PPU 202 to a pushbuffer (not explicitly shown in either FIG. 1 or FIG. 2) that may be located in system memory 104, parallel processing memory 204, or another storage location accessible to both CPU 102 and PPU 202. PPU 202 reads the command stream from the pushbuffer and then executes commands asynchronously relative to the operation of CPU 102.

Referring back now to FIG. 2, each PPU 202 includes an I/O unit 205 that communicates with the rest of the display system 100 via communication path 113, which connects to memory bridge 105 (or, in one alternative implementation, directly to CPU 102). The connection of PPU 202 to the rest of the display system 100 may also be varied. In some implementations, parallel processing subsystem 112 is implemented as an add-in card that can be inserted into an expansion slot of the display system 100. In other implementations, a PPU 202 can be integrated on a single chip with a bus bridge, such as memory bridge 105 or I/O bridge 107. In still other implementations, some or all elements of PPU 202 may be integrated on a single chip with CPU 102.

In one implementation, communication path 113 is a PCIe link, in which dedicated lanes are allocated to each PPU 202, as is known in the art. Other communication paths may also be used. As mentioned above, a contraflow interconnect may also be used to implement the communication path 113, as well as any other communication path within the display system 100, CPU 102, or PPU 202. An I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to parallel processing memory 204) may be directed to a memory crossbar unit 210. Host interface 206 reads each pushbuffer and outputs the work specified by the pushbuffer to a front end 212.

Each PPU 202 advantageously implements a highly parallel processing architecture. As shown in detail, PPU 202(0) includes an arithmetic subsystem 230 that includes a number C of general processing clusters (GPCs) 208, where C≧1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary dependent on the workload arising for each type of program or computation.

GPCs 208 receive processing tasks to be executed via a work distribution unit 200, which receives commands defining processing tasks from front end unit 212. Front end 212 ensures that GPCs 208 are configured to a valid state before the processing specified by the pushbuffers is initiated.

When PPU 202 is used for graphics processing, for example, the processing workload for operation can be divided into approximately equal sized tasks to enable distribution of the operations to multiple GPCs 208. A work distribution unit 200 may be configured to produce tasks at a frequency capable of providing tasks to multiple GPCs 208 for processing. In one implementation, the work distribution unit 200 can produce tasks fast enough to simultaneously maintain busy multiple GPCs 208. By contrast, in conventional systems, processing is typically performed by a single processing engine, while the other processing engines remain idle, waiting for the single processing engine to complete tasks before beginning their processing tasks. In some implementations of the present invention, portions of GPCs 208 are configured to perform different types of processing. For example, a first portion may be configured to perform vertex shading and topology generation. A second portion may be configured to perform tessellation and geometry shading. A third portion may be configured to perform pixel shading in screen space to produce a rendered image. Intermediate data produced by GPCs 208 may be stored in buffers to enable the intermediate data to be transmitted between GPCs 208 for further processing.

Memory interface 214 includes a number D of partition units 215 that are each directly coupled to a portion of parallel processing memory 204, where D 1. As shown, the number of partition units 215 generally equals the number of DRAM 220. In other implementations, the number of partition units 215 may not equal the number of memory devices. Dynamic random access memories (DRAMs) 220 may be replaced by other suitable storage devices and can be of generally conventional design. Render targets, such as frame buffers or texture maps may be stored across DRAMs 220, enabling partition units 215 to write portions of each render target in parallel to efficiently use the available bandwidth of parallel processing memory 204.

Any one of GPCs 208 may process data to be written to any of the DRAMs 220 within parallel processing memory 204. Crossbar unit 210 is configured to route the output of each GPC 208 to the input of any partition unit 215 or to another GPC 208 for further processing. GPCs 208 communicate with memory interface 214 through crossbar unit 210 to read from or write to various external memory devices. In one implementation, crossbar unit 210 has a connection to memory interface 214 to communicate with I/O unit 205, as well as a connection to local parallel processing memory 204, thereby enabling the processing cores within the different GPCs 208 to communicate with system memory 104 or other memory that is not local to PPU 202. In the implementation shown in FIG. 2, crossbar unit 210 is directly connected with I/O unit 205. Crossbar unit 210 may use virtual channels to separate traffic streams between the GPCs 208 and partition units 215.

Again, GPCs 208 can be programmed to execute processing tasks relating to a wide variety of applications, including but not limited to, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel shader programs), and so on. PPUs 202 may transfer data from system memory 104 and/or local parallel processing memories 204 into internal (on-chip) memory, process the data, and write result data back to system memory 104 and/or local parallel processing memories 204, where such data can be accessed by other system components, including CPU 102 or another parallel processing subsystem 112.

A PPU 202 may be provided with any amount of local parallel processing memory 204, including no local memory, and may use local memory and system memory in any combination. For instance, a PPU 202 can be a graphics processor in a unified memory architecture (UMA) implementation. In such implementations, little or no dedicated graphics (parallel processing) memory would be provided, and PPU 202 would use system memory exclusively or almost exclusively. In UMA implementations, a PPU 202 may be integrated into a bridge chip or processor chip or provided as a discrete chip with a high-speed link (e.g., PCIe) connecting the PPU 202 to system memory via a bridge chip or other communication means.

As noted above, any number of PPUs 202 can be included in a parallel processing subsystem 112. For instance, multiple PPUs 202 can be provided on a single add-in card, or multiple add-in cards can be connected to communication path 113, or one or more of PPUs 202 can be integrated into a bridge chip. PPUs 202 in a multi-PPU system may be identical to or different from one another. For instance, different PPUs 202 might have different numbers of processing cores, different amounts of local parallel processing memory, and so on. Where multiple PPUs 202 are present, those PPUs may be operated in parallel to process data at a higher throughput than is possible with a single PPU 202. Systems incorporating one or more PPUs 202 may be implemented in a variety of configurations and form factors, including desktop, laptop, or handheld personal computers, servers, workstations, game consoles, embedded systems, and the like.

### Example Architecture of Display System

FIG. 3 is a block diagram of an example display system 300, according to one embodiment of the present invention. The display system 300 includes hardware components including, without limitation, a display controller 305 and a display screen 111 (e.g., display panel), which are coupled. The display controller 305 includes an image receiver 310, a first window controller 315, a second window controller 320, a third window controller 322, a fourth window controller 324, and a blender component 325. The image receiver 310 is coupled to the first window controller 315, the second window controller 320, the third window controller 322, and the fourth window controller 324, which are coupled to the blender component 325, which is coupled to the display screen 111.

The display controller 305 is one implementation of the parallel processing subsystem 112 of FIGS. 1 and 2. The display controller 305 may be a part of a system-on-chip (SoC) of the display system 100 of FIG. 1. In one implementation, the display controller 305 does not include software.

The image receiver 310 of FIG. 3 is configured to fetch (e.g., receive, retrieve, etc.) image data from a source 302 (e.g., memory of a media player, DVD player, computer, tablet computer, smart phone, etc.). The image data includes a first image (e.g., pixels to be viewed by a left eye), a second image (e.g., pixels to be viewed by a right eye), a third image (e.g., monoscopic image), and/or a fourth image (e.g., image that receives neither stereoscopic processing nor monoscopic processing). The image receiver 310 is configured to send the first image to the first window controller 315. The image receiver 310 is configured to send the second image to the second window controller 320. The image receiver 310 is configured to send the third image to the third window controller 322. The image receiver 310 is configured to send the fourth image to the fourth window controller 322. A clock CLK configures the display controller 305 to synchronize operations with the source 302 and/or to synchronize operations among components of the display controller 305.

A “stereoscopic” (stereo) image includes an image that has a binocular perception of three-dimensional (3D) depth without the use of special headgear or glasses on the part of a viewer. When a viewer normally looks at objects in real life (not on a display screen) the viewer's two eyes see slightly different images because the two eyes are located at different viewpoints. The viewer's brain puts the images together to generate a stereoscopic viewpoint. Likewise, a stereoscopic image on a display screen is based on two independent channels, for example, the left input field and the right input field of the blender component 325. To achieve a 3D depth perception, a left image and a right image that are fed into the left input field and the right input field, respectively, of the blender component 325 are similar but not exactly the same. The blender component 325 uses the two input fields to receive the two slightly different images and to scan out a stereoscopic image that provides the viewer with a visual sense of depth.

In contrast, a “monoscopic” (mono) image includes an image that is perceived by a viewer as being two-dimensional (2D). A monoscopic image has two related channels that are identical or at least intended to be identical. To achieve a 2D depth perception, the left image and the right image fed into the blender component 325 are the same or at least intended to be the same. The blender component 325 uses the two fields to receive the two same images to give the viewer no visual sense of depth. Accordingly, there is no sense of depth in a monoscopic image. When generating a monoscopic image for the display screen 111, the default calculations for a monoscopic image are based on an assumption that there is one eye centered between where two eyes would be. The result is a monoscopic image that does not have depth like a stereoscopic image has depth.

The first window controller 315 scales the first image (e.g., left-eye image) to the appropriate scaling parameters of the display screen 111. The second window controller 320 scales the second image (e.g., right-eye image) to the appropriate scaling parameters of the display screen 111. The third window controller 322 scales a monoscopic image to the appropriate scaling parameters of the display screen 111. The fourth window controller 322 is configured to receive a pre-composited image from a software module (not shown) that is external to the display controller 305. The first window controller 315, the second window controllers 320, the third window controller 322, and/or the fourth window controller 324 each send respective scaled images to the blender component 325.

In one implementation, the blender component 325 is a multiplexer (mux). The blender component 325 is configured to interleave (e.g., composite, blend, etc.), among other things, the first image and the second image into a corresponding interleaving format (e.g., row interleave, column interleave, checkerboard interleave, or sub-pixel interleave, etc.), which is discussed below with reference to FIGS. 4-6. If the display controller 305 is unable to process image data appropriately according to an interleaving format selector 330 and/or a blending format selector 332, then a software module (not shown) manages processing operations for interleaving and/or blending formatting.

The blender component 325 can scan out to the display screen 111 a combination of windows according to one or more selections of the blending format selector 332 (e.g., stereo, mono, and/or normal, etc.), which is discussed below with reference to FIGS. 7A and 7B. The display screen 111 is autostereoscopic (e.g., capable of displaying the composited image in glasses-free 3D). The blender component 325 scans out the composited image to the display screen 111 in real-time without accessing (e.g., without making another memory pass to) a memory that stores additional data associate with the stereoscopic composited image. For example, the blender component 325 scans out the composited image to the display screen 111 without accessing a memory of the source 302 and/or a memory the display system 300. As another example, blender component 325 scans out the composited image to the display screen 111 in real-time without performing another read operation and/or write operation with the source 302 and/or with local memory at the display system 300. In one implementation, the display controller 305 scans out a composited image in a “just-in-time” manner that is in sync with the clock CLK. In such a case, the hardware components of the display controller 305 do not get hung up waiting for other processes to complete like a software program tends to do.

Advantageously, because the hardware components of the display system 300 do not need to perform an additional memory pass before scanning the composited image to the display screen 111, the display system 300 substantially eliminates the corresponding memory bandwidth issues and/or the memory input/output (I/O) power overhead issues that are suffered by conventional systems. By using hardware components, the display controller 305 natively supports interleaving images of two hardware window controllers to generate a composited image. Also, because the display system 300 performs fewer passes to memory, the display system 300 consumes less power. Accordingly, where the display system 300 is powered by a battery, the display system 300 draws less battery power, thereby extending the battery charge duration. The display controller 305 also supports blending the composited image with a monoscopic image and/or with a pre-composited image. The display system 300 also supports various selections of the interleaving format selector 330, selections of the blending format selector 332, and/or timing programming according to the clock CLK in order to scan out an appropriate image to the display screen 111.

The display system 300 may be implemented on a dedicated electronic visual display, a desktop computer, a laptop computer, tablet computer and/or a mobile phone, among other platforms. Implementations of various interleaving formats in the display system 300 are discussed below with reference to FIGS. 4-6.

### Interleaving Formats

Referring again to FIG. 3, in one implementation, autostereoscopy requires pixels to alternate between the first image, the second image, the first image, the second image, and so on. The manner in which the pixels alternate depends on the interleaving format (e.g., column interleave, row interleave, checkerboard interleave, and/or sub-pixel interleave, etc.). For example, if the interleaving format is set to column interleave, the final composited image that the display controller 305 sends out to the display screen 111 includes columns of pixels interleaved from the first image and the second image.

The display controller 305 can either pre-decimate content meant for the auto-stereoscopic panel, or may deliver an image to the display screen 111 at full resolution, as shown below with reference to FIGS. 4 and 5. The display system is configured to accept both types of content and produce an image that is as wide as the desired output resolution, while also having the first image and the second image interleaved.

As described above, the display system 300 utilizes a first window controller (e.g., for processing a first image) and a second window controller (e.g., for processing a second image) with a blender component 325 (e.g., smart mux) in the display controller 305 to implement interleaved stereoscopic support. The two windows (e.g., first image and second image) are treated as originating from the same image and having a common depth. The display controller 305 uses the two windows to generate a composite stereoscopic image. The blender component 325 is configured to receive pixels from the two post-scaled windows in a manner required to support at least one of the following interleaving formats: row interleave, column interleave, checkerboard interleave, or sub-pixel interleave.

FIGS. 4-6 describe characteristics of various interleaving formats. Regarding the image content, the first image and the second image are stored in separate blocks of memory. A window can be pre-decimated or non-pre-decimated. A pre-decimated window is typically half the screen width or height. A non-pre-decimated window is typically all of the screen width or height. The blender component 325 performs interleaving after the first window controller 315 and the second window controller 320 have performed scaling operations.

FIG. 4 is a conceptual diagram illustrating stereoscopic pixel interleaving from a pre-decimated source, according to one embodiment of the present invention. This examples shows column interleaving. The display controller typically performs column interleaving when the display system is set to a landscape mode, which describes the way in which the image is oriented for normal viewing on the screen. Landscape mode is a common image display orientation. Example landscape ratios (width×height) include 4:3 landscape ratio and 16:9 widescreen landscape ratio. The display controller typically performs interleaving on a pixel-by-pixel basis. If the display controller is configured with parallel processing capabilities, then the display controller can interleave multiple pixels at once.

Pre-decimated means the windows (415, 420) are filtered down to half the resolution of the screen (or half the resolution of the window in which the image is to be displayed) before the display controller receives the windows (415, 420). For example, if the screen has a resolution of 1920 pixels (width)×1200 pixels (height), then the first image 415 includes 960 columns of pixels, and the second image 420 includes 960 columns of pixels; each column of each window has 1200 pixels, which is the height of the screen. In another example, if a window that is a subset of the screen has a resolution of 800 pixels (width)×600 pixels (height), then the first image 415 includes 400 columns of pixels, and the second image 420 includes 400 columns of pixels; each column of each window has 600 pixels, which is the height of the window.

For explanatory purposes, only portions of the images (415, 420) and the composited image 425 are shown. FIG. 4 shows 12 columns for the first image 415 and 12 columns for the second image 420. Each column of each image (415, 420) includes a single column of pixels.

For pre-decimated images, as shown in FIG. 4, the display controller interleaves all (or substantially all) pixels from each image (415, 420). The display controller can treat columns of the first image 415 as being odd columns for the composited image 425, and treat pixels of the second image 420 as being even columns for the composited image 425, or vice versa. Other combinations of column assignments are also within the scope of this technology. The display controller then generates a composited image 425 and scans the composited image 425 onto the screen for viewing.

FIG. 5 is a conceptual diagram illustrating stereoscopic pixel interleaving from a non-pre-decimated source, according to one embodiment of the present invention. Like FIG. 4, FIG. 5 also shows column interleaving, except this example illustrates an image that is non-pre-decimated. General features of column interleave are described above with reference to FIG. 4.

Non-pre-decimated means the images (515, 520) are unfiltered at full resolution of the screen (and/or full resolution of the window in which the image is to be displayed) before the display controller receives the images (515, 520). For example, if the screen has a resolution of 1920 pixels (width)×1200 pixels (height), then the first image 515 includes 1920 columns of pixels, and the second image 520 includes 1920 columns of pixels; each column of each window has 1200 pixels, which is the height of the screen. In another example, if a window that is a subset of the screen has a resolution of 800 pixels (width)×600 pixels (height), then the first image 515 includes 800 columns of pixels, and the second image 520 includes 800 columns of pixels; each column of each window has 600 pixels, which is the height of the window.

For explanatory purposes, only portions of the images (515, 520) and the composited image 525 are shown. The example of FIG. 5 shows 24 columns for the first image 515 and 24 columns for the second image 520. Each column of each window (515, 520) includes a single column of pixels.

For non-pre-decimated images, as shown in FIG. 5, the display controller interleaves half the pixels from each window (515, 520) and disregards the other half. For example, the display controller filters (e.g., drops) the 24 columns shown for the first image 515 down to 12 columns, and filters the 24 columns shown for the second image 520 down to 12 columns. The display controller can treat odd columns of the first image 515 as being odd columns for the composited image 535, and treat odd columns of the second image 520 as being even columns for the composited image 525, or vice versa. Alternatively, the display controller can treat odd columns of the first image 515 as being even columns for the composited image 535, and treat odd columns of the second image 520 as being odd columns for the composited image 525, or vice versa. Other combinations of column assignments are also within the scope of this technology. The display controller then generates a composited image 525 from the filtered windows and scans the composited image 525 onto the screen for viewing.

In another implementation, the display controller can carry out row interleaving (not shown), as opposed to column interleaving. The display controller typically performs row interleaving when the display system is set to a portrait mode, which describes the way in which the image is oriented for normal viewing on the screen. Landscape mode is a common image display orientation. To implement row interleaving and/or portrait mode, the display controller rotates images from a memory (e.g., a memory of the source or a memory of the display system). Procedures for row interleaving are substantially the same as column interleaving, but instead rows of pixels are interleaved.

In another implementation, the display controller can carry out checkerboard interleaving (not shown). Checkerboard interleaving is a subset of column interleaving and/or row interleaving. To implement checkerboard interleaving, the display controller switches the beginning pixel of each row (or column) between a pixel of the first image and then a pixel of the second image in the next row (or column). For example, each pixel column of the composited image includes alternating pixels between a pixel the first image a pixel of the second image in order to form a checkerboard pattern in the composite image. The resulting composited image thereby resembles a checkerboard pattern.

FIG. 6 is a conceptual diagram illustrating stereoscopic sub-pixel interleaving, according to one embodiment of the present invention. When set for sub-pixel interleaving, the display controller is configured to interleave alternating between pixels of first (left) image and second (right) image and alternating between red-green-blue (RGB) values among the pixels. In this example, the display controller performs sub-pixel interleaving of a first image 615 and a second image 620 to generate a composited image 625.

For explanatory purposes, only portions of the sub-images (615, 620) and the composited image 625 are shown. Pixels L0 and L1 of the first image 615 are shown, each pixel having a separate value for red, green, and blue. Likewise, pixels R0 and R1 of the second image 620 are shown, each pixel having a separate value for red, green, and blue. Pixels P0, P1, P2, and P3 are shown for the composited image 625.

For example, pixel P0 of the composited image 625 is a composite of the red value of pixel L0, the green value of pixel R0, and the blue value of pixel L0. Pixel P1 is a composite of the red value of pixel R0, the green value of pixel L0, and the blue value of pixel R0. Pixel P2 of the composited image 625 is a composite of the red value of pixel L1, the green value of pixel R1, and the blue value of pixel L1. Pixel P3 is a composite of the red value of pixel R1, the green value of pixel L1, and the blue value of pixel R1. Other combinations of interleaving sub-pixels are also within the scope of the present technology. The display controller then generates a composited image 625 based on the composited pixels and scans the composited image 625 onto the screen for viewing.

Displaying a Stereoscopic Window with a Monoscopic Window

Referring again to FIG. 3, in some implementations, the blender component 324 can scan to the display screen 111 a monoscopic window (e.g., window C) to the display screen 111. The blender component 324 is configured to place the monoscopic window either over (e.g., above, on top of, in front of) or under (e.g., below, behind) the composite stereoscopic window (e.g., first and second windows). Accordingly, the third window controller provides programmable support as a monoscopic window. For example, a programmer can utilize the third window controller 322 to display a monoscopic image on a monoscopic window. The third window controller 322 can input a monoscopic image into both the left input field and the right input field of the blender component 325, which can then generate the monoscopic image and scan the monoscopic image to the display screen 111. The display system 300 can also disable the monoscopic window feature.

FIG. 7A is a conceptual diagram illustrating a monoscopic window 704 that is scanned out over a stereoscopic window 702, according to one embodiment of the present invention. Referring to FIG. 3, the blender component blends the stereoscopic image with the monoscopic to generate a blended image that, in turn, may be directly scanned to the display screen 111 in a “just in time” manner. The display system 300 scans out the monoscopic window 704 to the display screen 111 such that the monoscopic window 704 appears to be in front of the stereoscopic window 702. The stereoscopic window 702 is a result of the display controller interleaving the first and second windows. Stereoscopic interleaving operations are described above with reference to FIGS. 3-6. The monoscopic window 704 is a result of replicating data of a window C into both sides of a blender component of the display controller. For example, as described above with reference to FIG. 3, the display controller 305 can provide a monoscopic image to the display screen 111 by replicating, via the third window controller, the monoscopic image data into both sides of the blender component 325.

FIG. 7B is a conceptual diagram illustrating a stereoscopic window 708 that is scanned out over a monoscopic window 706, according to one embodiment of the present invention. FIG. 7B is similar FIG. 7A, except FIG. 7B shows the monoscopic window 706 behind the stereoscopic window 708. For example, the display system 300 scans out the monoscopic window 706 to the display screen 111 such that the monoscopic window 706 appears to be behind the stereoscopic window 706.

A software module (not shown) typically manages aligning the windows for the display screen 111 in FIGS. 7A and 7B. For example, the software module provides coordinates at which a monoscopic window and/or a stereoscopic window are scanned to the display screen 111.

Referring back to FIG. 3, in another embodiment, the display controller 305 can include N stereoscopic window controller pairs, where N is a positive integer; and M monoscopic window controllers, where M is an integer. The blender is further configured to composite, in a layered manner, images of the N stereoscopic window controller pairs with images of the M monoscopic window controllers. For example, the blending shown in FIGS. 7A and 7B can be increased from compositing the one stereoscopic image 702 with the one monoscopic image 704, to compositing multiple stereoscopic images with multiple monoscopic images, in any combination.

In an alternative embodiment, the display system 300 can scan out a stereoscopic window with a normal window. As described above with reference to FIG. 3, a normal window is a window that receives neither stereoscopic processing nor monoscopic processing from the display controller 305. For example, the fourth window controller 324 can receive a pre-composited image from a software module (not shown) that is external to the display controller 305. The display system 300 can scan out pre-composited image data to the display screen 111 (e.g., by using the fourth window controller 324), along with a stereoscopic window (e.g., by using the first and second window controllers) and/or a monoscopic window (e.g., by using the third window controller).

Accordingly, the implementation of the fourth window controller 324 configures the display controller to scan out multiple stereoscopic windows to the display screen 111. For example, a software module (not shown) manages the compositing of a second stereoscopic image and uses the fourth window controller 324 to display the second stereoscopic window. The display controller 305 can scan out that second stereoscopic window along with a first stereoscopic window that the display controller 305 composites in hardware by using the blender component 325. Accordingly, the blender component 325 is configured to blend normal, stereoscopic and/or monoscopic windows.

Operating parameters of the blender component 325 are set according to the interleaving format selector 330 and/or the blending format selector 332. The setting of a particular interleaving format selector 330 determines whether particular image data is to receive column interleave, row interleave, checkerboard interleave, and/or sub-pixel interleave, among other types of interleaving. The setting of a particular blending format selector 332 determines whether the blender component 325 is to treat particular image data as being stereo, mono, or normal.

In one implementation, the blender component 325 includes a multiplexer (mux) that includes circuitry for processing according to various selections of the interleaving format selector 330 and/or the blending format selector 332. The circuitry can include an arrangement of hardware gates (e.g., OR gates, NOR gates, XNOR gates, AND gates, and/or NAND gates, etc.) that configure the blender component 325 to interleave two or more data streams received from the first window controller 315, the second window controller 320, and/or the third window controller 322. The circuitry of the blender component 325 may also include an arrangement of electronic switches for setting the circuitry to process image data according to the interleaving format selectors 330 (e.g., column, row, checkerboard, sub-pixel, etc.) and/or the blending format selectors 332 (e.g., stereo, mono, normal, etc.). In light of the descriptions above with reference to FIGS. 3-7, an appropriate circuit arrangement for the blender component 325 and/or other circuitry of the display controller 305 will be apparent to a person skilled in the art.

The invention has been described above with reference to specific embodiments and numerous specific details are set forth to provide a more thorough understanding of the invention. Persons skilled in the art, however, will understand that various modifications and changes may be made thereto without departing from the broader spirit and scope of the invention. The foregoing description and drawings are, accordingly, to be regarded in an illustrative rather than a restrictive sense.

What is claimed is:

1. A display controller for controlling a display screen of a display system, the display controller comprising:
an image receiver configured to receive image data from a source that includes a first image and a second image;
a first window controller coupled to the image receiver and configured to receive the first image from the image receiver and to scale the first image according to parameters of a display screen to generate a scaled first image;
a second window controller coupled to the image receiver and configured to receive the second image from the image receiver and to scale the second image according to the parameters of the display screen to generate a scaled second image; and
a blender component coupled to the first window controller and the second window controller and configured to interleave the scaled first image with the scaled second image in order to generate a stereoscopic composited image.

2. The display controller of claim 1, wherein the blender component is further configured to scan out the stereoscopic composited image to the display screen without accessing a memory that stores additional data associate with the stereoscopic composited image.

3. The display controller of claim 1, wherein the blender component includes hardware circuitry to interleave the scaled first image with the scaled second image.

4. The display controller of claim 1, further comprising one or more interleaving format selectors configured to set the blender component to interleave the scaled first image and the scaled second image according to an interleave format, including at least one of column interleave, row interleave, checkerboard interleave, or sub-pixel interleave.

5. The display controller of claim 1, wherein the blender component is further configured to interleave the scaled first image with the scaled second image according to a column interleave format through which pixel columns of the scaled first image are interleaved with pixel columns of the scaled second image.

6. The display controller of claim 1, wherein the blender component is further configured to interleave the scaled first image with the scaled second image according to a row interleave format through which pixel rows of the first image are interleaved with pixel rows of the second image.

7. The display controller of claim 1, wherein the blender component is further configured to interleave the scaled first image with the scaled second image according to a checkerboard interleave format, wherein for each pixel column of the composited image the blender component is configured to alternate pixels between a pixel the first image and a pixel of the second image in order to form a checkerboard pattern in the stereoscopic composited image.

8. The display controller of claim 1, wherein the blender component is further configured to interleave the scaled first image with the scaled second image according to a sub-pixel interleave format, wherein for each pixel of the stereoscopic composited image the blender component is configured to alternate red-green-blue (RGB) values among alternating pixels from the scaled first image and the scaled second image.

9. The display controller of claim 1, further comprising a third window controller coupled to the image receiver, wherein the blender component includes a left input field coupled to the third window controller and a right input field coupled to the third window controller, and wherein the blender component is further configured to scan out a monoscopic image to the display screen based on input received from the third window controller.

10. The display controller of claim 9, wherein the display controller is further configured to blend the stereoscopic composited image with the monoscopic image to generate a blended image, and to scan out the blended image to the display screen.

11. The display controller of claim 10, wherein the display controller is further configured to scan out the blended image to the display screen, wherein the blended image provides a perception of the monoscopic image being either in front of the stereoscopic composited image or behind the stereoscopic composited image.

12. The display controller of claim 9, wherein the blender controller further comprises one or more blending format selectors configured to set the blender component to blend the stereoscopic composite image with the monoscopic image.

13. The display controller of claim 9, wherein a stereoscopic window controller pair includes the first window controller and the second window controller comprise, and wherein a monoscopic window controller includes the third window controller, and wherein the display controller further comprises:
N stereoscopic window controller pairs; and
M monoscopic window controllers, wherein the blender is further configured to composite in a layered manner images of the N stereoscopic window controller pairs with images of the M monoscopic window controllers.

14. The display controller of claim 1, further comprising a fourth window controller coupled to the image receiver and to the blender component, and wherein the blender component is further configured to scan out a pre-composited image to the display screen based on input received from the fourth window controller, and wherein the pre-composited image is composited before being received at the image receiver of the display controller and includes a composite of images that are interleaved according to a stereoscopic interleave format.

15. The display controller of claim 14, wherein the display controller is further configured to blend the stereoscopic composited image with the pre-composited image to generate a blended image, and wherein the blender controller is further configured to scan out the blended image to the display screen, and wherein the blended image provides a perception of the pre-composited image being either in front of the stereoscopic composited image or behind the stereoscopic composited image.

16. An integrated circuit, comprising:
a display controller for controlling a display screen of a display system and including:
an image receiver configured to receive image data from a source that includes a first image and a second image;
a first window controller coupled to the image receiver and configured to receive the first image from the image receiver and to scale the first image according to parameters of a display screen to generate a scaled first image;
a second window controller coupled to the image receiver and configured to receive the second image from the image receiver and to scale the second image according to the parameters of the display screen to generate a scaled second image; and
a blender component coupled to the first window controller and the second window controller and configured to interleave the scaled first image with the scaled second image in order to generate a stereoscopic composited image.

17. The integrated circuit of claim 16, wherein the blender component is further configured to scan out the stereoscopic composited image to the display screen without accessing a memory that stores additional data associate with the stereoscopic composited image.

18. The integrated circuit of claim 16, wherein the display controller further comprises one or more interleaving format selectors configured to set the blender component to interleave the scaled first image and the scaled second image according to an interleave format, including at least one of column interleave, row interleave, checkerboard interleave, or sub-pixel interleave.

19. The integrated circuit of claim 16, wherein the display controller further comprises a third window controller coupled to the image receiver, wherein the blender component includes a left input field coupled to the third window controller and a right input field coupled to the third window controller, and wherein the blender component is further configured to scan out a monoscopic image to the display screen based on input received from the third window controller.

20. A method of controlling a display screen of a display system, the method comprising:
receiving image data from a source, wherein the image data includes a first image and a second image;
scaling the first image according to parameters of the display screen in order to generate a scaled first image;
scaling the second image according to the parameters of the display screen in order to generate a scaled second image;
interleaving the scaled first image with the scaled second image in order to generate a stereoscopic composited image; and
scanning out the stereoscopic composited image to the display screen without accessing a memory that stores additional data associate with the stereoscopic composited image.
